(19) United States
(12) Patent Application Publication
(10) Pub. No.: US 2019/0291328 A1
(43) Pub. Date: Sep. 26, 2019

(54) APPARATUS FOR EXPANDING PLASTICS MATERIAL CONTAINERS WITH DOUBLE-ACTING PRESSURE GENERATING DEVICE

(71) Applicant: KRONES AG, Neutraubling (DE)

(72) Inventors: DIETER FINGER, NEUTRAUBLING (DE); ANDREAS VORNEHM, Offenberg (DE); DOMINIK MEIER, Parsberg (DE); THOMAS KITZINGER, Regensburg (DE); ANDREAS PENSE, Regensburg (DE); CORA HANESCH, Regensburg (DE); CHRISTIAN BETZ, Geigant (DE)

(21) Appl. No.: 16/207,742

(22) Filed: Dec. 3, 2018

(30) Foreign Application Priority Data
Mar. 23, 2018 (DE) 10 2018 106 932.4

(51) Int. Cl. B29C 49/46; B29C 49/12; B29C 49/28; B29C 49/62

(52) U.S. Cl. CPC B29C 49/46; B29C 49/12; B29L 2031/7158; B29C 49/62; B29C 2049/465; B29C 49/28

(57) ABSTRACT

Apparatus is provided for expanding plastics material parisons into plastics material containers by a liquid medium, having at least one transforming station, which fills and expands the plastics material parisons with the liquid medium with at least one pressure generating device, which is suitable and intended to deliver the liquid medium to at least one filling device, which filling device fills the plastics material parisons with the liquid medium, wherein the pressure generating device has a pressure outlet which at least at times can be fluidically connected to the plastics material parison to be filled. The apparatus has a removal device which is suitable and intended at least at times to remove a flowable medium from a plastics material container, wherein the pressure generating device has a suction intake which at least at times can be fluidically connected to this removal device in order to remove the flowable medium.

### CROSS-REFERENCE TO RELATED APPLICATION

This application claims priority to German Application No. 10 2018 106 932.4, having a filing date of Mar. 23, 2018 the entire contents of which are hereby incorporated by reference.

### FIELD OF TECHNOLOGY

The following relates to an apparatus and a method for expanding plastics material parisons into plastics material containers. Such apparatus and methods have been known for a long time from the known art. In this case heated plastics material parisons are usually first of all expanded and then the bottles thus produced are filled with a product. More recently, however, procedures have also become known in which the plastics material parisons are not initially expanded with compressed air, but in which the plastics material parisons are directly filled with a liquid medium, in particular the product to be introduced.

### BACKGROUND

In the moulding of containers or bottles with filling material, however, the problem arises that, for moulding, more filling material must be used than will later actually remain in the container. Therefore, gas must enter the so-called head space of the containers, in order to set a so-called filling level (edge between filling material and head space gas). Depending upon technical necessity, different or various filling levels may be necessary. Thus, an adjustability with simultaneous reproducibility of the respective filling level should be guaranteed.

From the internal known art belonging to the applicant it is known to use a siphon effect in which a positive pressure is released via the container into a geometrically lower receiving container and thus a negative pressure is set in the container (brought about by a suction effect in the case of siphons). At present this negative pressure is not prevented and not vented. Due to the lack of venting it can happen that the container is deformed, and volume is displaced. Then, a stretching rod is used to displace a specific volume by means of the position of the stretching rod in the filling material (this is produced by the square of the stretching rod radius times 7C times the height inside the filling material) and thus after subsequent venting a specific head space volume is set in the bottle or the container.

Alternatively, it would also be possible to extract volume from the container. For this purpose, vacuum pumps are used in the internal known art belonging to the applicant. In addition, with the aid of a gas which is under a positive pressure filling material can also be displaced and so a filling level can be set.

In order that on the suction side of the pressure generating device (or the side of the piston remote from the positive pressure) no too excessive negative pressure is produced, this side is vented or possibly put under pressure.

For the extraction according to the internal known art belonging to the applicant, at present a vacuum pump is required which requires intensive maintenance and is very expensive. The displacement of the filling material with the stretching rod also has the disadvantage that the stretching rod geometry is only variable within certain limits. Thus, the stretching rod must be a certain distance from the inside of the plastic parison in order to avoid contact by the stretching rod or to still ensure the filling of the plastic parison with filling material.

Thus, it can happen that the stretching rod has to be positioned too far down in the container in order to achieve the filling level in the container and so a long movement path is necessary, which requires process time. It can also happen that the volume which the stretching rod displaces is not sufficient in order to set the required filling level or head space. This can occur in particular if the head space volume is greater than the stretching rod volume inside the container. Through the lack of pressure relief or ventilation during the displacement of filling material with the aid of a siphon effect between a pressure relief and a movement of the stretching rod in the filling material a very high negative pressure is produced in the filling material.

This can lead to the container collapsing. When the container collapses or implodes, (predetermined) breaking points are produced in the bottle side wall which, in the event of subsequent mechanical stress or in the event of top loads, lead to a premature failure, unlike containers without these (predetermined) breaking points. If the stretching rod is now moved briefly inside a sealed bottle (no more filling material can enter the bottle), in order for example to displace filling material between the seal of the filling head and the upper edge of the mouthpiece, in the container a further negative pressure is generated which leads to still more (predetermined) breaking points and also to a mechanically poorer container (in particular a bottle).

### SUMMARY

An aspect relates to an apparatus and a method which on the one hand simplifies the procedures according to the known art and on the other hand is also designed to be more variable.

An apparatus according to embodiments of the invention for expanding plastics material parisons into plastics material containers by means of a liquid medium has at least one transforming station, at least two transforming stations, which fill and expand the plastics material parisons with the liquid medium. Furthermore, the apparatus has at least one pressure generating device, which is suitable and intended to deliver the liquid medium to at least one filling device which fills the plastics material containers with the liquid medium. In this case the pressure generating device has a pressure output which at least intermittently can be fluidically connected to the plastics material parison to be filled.

According to embodiments of the invention the apparatus has a removal device which is suitable and intended at least at times to remove a flowable medium from a plastics material container, wherein the pressure generating device has a suction intake which at least at times can be fluidically connected to this removal device in order to remove the flowable medium.

The flowable medium is the liquid to be filled. This liquid can be for instance an “easy-flowing” liquid such as for instance water, juices, milk, beers or wines. However, the liquid can also be viscous liquids such as sauces, oils or the like. In addition, the liquid to be filled can be both carbonated liquids and non-carbonated liquids.

In this case the container from which the liquid is removed can also be the container which is expanded, but it would also be possible that the removal device removes liquid from another container, in particular a container expanded by another transforming station.

A pressure generating device can be fluidically connected to at least one transforming station (and in particular to the filling devices and/or removal devices of this at least one and these at least two transforming stations). The apparatus has, as mentioned above, at least two or at least four transforming stations.

It is pointed out that the terms “plastics material container” and “plastics material parison” are in some instances used synonymously. This is because the plastics material parison is transformed by the transforming process described here into the plastics material container and therefore during the filling process reference may not always be made unambiguously to a plastics material parison or a plastics material container.

The plastics material containers to be expanded and to be filled are containers which are produced from a material selected from a group of materials including PET, HDPE, PP and the like. The containers to be expanded and filled are bottles.

The flowable medium is advantageously a liquid medium and the filling material. In this case it is possible that the liquid is removed from the container which has just been expanded, but liquid can also be removed from another container. In this case this can be in particular a container which has already been (at least for the most part) filled and expanded.

It is therefore proposed that here too liquid is drawn off from the container or another container, but, instead of the vacuum pump used in the known art, a suction side of the pressure generating device is used directly. In contrast to the known art, in which one side of the pressure generating device is vented or is acted upon by positive pressure, the negative pressure produced on the suction side of the pressure generating device can be used in order to draw off filling material from this container of the said transforming station or another station (and/or a container treated by this station). Alternatively, it would also be conceivable to draw off liquid by means of the suction side of a vacuum pump. In this case, as explained in greater detail below, the resulting negative pressure can be used for example in order to draw off filling material through a hollow stretching rod or an additional channel. In this case this filling material can be returned into another region.

The pressure generating device has a piston element which is movable relative to a liquid chamber. This piston element can, by its movement with respect to this liquid chamber, on the one hand, generate the pressure of the liquid which expands the container and on the other hand can generate a negative pressure relative to another portion of the receiving chamber which in turn can be used to draw off liquid. The piston element divides the liquid chamber into two chamber portions.

In an advantageous embodiment the pressure output and the suction intake are arranged on different sides of the liquid chamber with respect to the piston element. In this embodiment a first movement of the piston element in a first direction of movement is used in order to fill the container with the liquid. This movement of the piston element (in the same direction) is also used in order to draw off or remove liquid from this container or a further container (by means of the suction intake).

In an advantageous embodiment the pressure output and the suction intake are arranged on the same side of the liquid chamber with respect to the piston element. In this embodiment a first movement of the piston element in a first direction of movement is used in order to fill the container with the liquid. A second movement of the piston element (which is a movement in the opposite direction) is used in order to draw off or remove liquid from this container or a further container.

In a preferred embodiment the pressure generating device has a piston. However, embodiments can also be used which, instead of or in addition to a piston, use other elements, for instance rotating elements, in order to generate a negative pressure on one side and a positive pressure on the other side.

In a preferred embodiment the apparatus has a movable carrier on which the transforming stations are disposed. The movable carrier is advantageously a carrier which is rotatable relative to an axis of rotation. Particularly several transforming stations are arranged on the carrier. Thus, for example between 5 and 60 transforming stations can be arranged on this carrier. It is pointed out that the transforming stations also serve as filling stations. Alternatively, it would also be conceivable that the transforming stations are arranged in a stationary manner.

Alternatively, it would also be possible that the apparatus transports the transforming stations and/or the containers to be transformed at least partially along a rectilinear transport path. Thus, the apparatus could for instance have a transport chain which is guided for example along an oval with rectilinear route portions. The transforming stations could also be arranged on magnet shuttles which move along a stator.

The advantage when stationary transforming stations are used is that no centrifugal forces occur during the transforming process. In addition, lesser problems also occur with accelerations and decelerations during driving of the shaping wheel.

In a further preferred embodiment, the filling device has an application device which can be applied to the rim of the mouth of the plastics material parisons in order to fill them with the liquid medium (and in order also to expand them). Advantageously, in this case this filling device rests sealingly on the rim of the mouth of the respective plastics material parison. Furthermore, the filling device can have valve devices in order to control the delivery of the product into the plastics material parisons. In this case it is also possible that during an expansion operation the liquid is conveyed with different pressures into the plastics material parisons.

In a preferred embodiment the individual transforming stations also have transforming moulds, inside which the plastics material parisons are expanded by application of the liquid medium. In this case these transforming moulds can be opened and closed, wherein the expansion of the plastics material parisons is possible in a closed operation. In this case it is possible that these transforming moulds have mould parts which are pivotable with respect to one another and in particular are pivotable with respect to one another with respect to an axis which extends parallel to the longitudinal direction of the plastics material parison.

In a further advantageous embodiment, the apparatus has a receiving device for liquid medium removed from the container. In this case this may be an additional reservoir, inside which extracted medium can be stored temporarily. In addition to or alternatively to the reservoir the liquid can, however, also be stored in pipe sections.

Thus, it is possible that the negative pressure (more precisely, the liquid) is stored in a tank if required. In the event of a sealed container, here too a collapse of the container can be initiated or, however, in the event of a vented container the required amount of filling material can be drawn off. The amount of filling material which then accumulates in a collection container can for example either be fed again by means of a valve or an outlet to a product bowl, such as a collecting device for the product, or can also be used in other ways.

The negative pressure could also be used for example for drawing off drops in the sealing region of the filling head. Thus, a movement of the piston device produces both a pressure for feeding the liquid into the container and a suction action for drawing off liquid from this container or another container. In this case it is possible that the pressure is generated by a downward movement or an upward movement of the piston or by a horizontal movement, depending upon how the piston or the pressure generating device is oriented or arranged.

The embodiment described here can be used both with single-acting pistons and with double-acting pistons and with parallel-connected pistons. In a preferred embodiment it would also be conceivable that a direction of movement of the piston is used in order to fill a specific transforming station or the container located in this transforming station with the liquid, and the other, opposing direction of movement of the piston is used in order to fill a further transforming station or the container located in this further transforming station with the liquid.

In addition, sealing of the stretching rod can also take place at least at times, so that temporarily drawing off of liquid is not possible.

In this case this sealing of the stretching rod can be used for example by means of the contact to the ridge of the plastics material parison and the stretching rod during longitudinal stretching. In this case it would also be sufficient to design only the container, the head and the cylinder to be pressureless before the extraction is started. In addition, it would also be possible to apply a low positive pressure, in particular if the medium to be filled has a certain compressibility, for instance because it is a mixture of the product to be filled and air.

Due to a connection of a stretching rod or an additional conduit it is also possible for a negative pressure to be used on the suction side of the pressure generating device in order to adjust the filling level. In a further preferred embodiment, a Venturi effect is used instead of a vacuum pump. Thus it is possible that instead of venting one side or supplying positive pressure, a corresponding negative pressure which is produced when the product flows through a narrow point is used in order to draw off filling material from a container of the own transforming station or another transforming station (in particular in the carousel or linear guide assembly).

A resulting negative pressure can also be used for example in order to draw off filling material through a hollow stretching rod or an additional channel. In addition, switching of the extraction is also possible by means of an automatic and/or switchable valve. In addition, it would also be possible to vent the container by means of a hollow stretching rod and an optionally switchable non-return valve in the stretching rod.

In a further advantageous embodiment, the apparatus has a receiving device for liquid medium removed from the container. In this case this receiving device can be an additional collection container. In a further advantageous embodiment, the apparatus has a closing device in order to close a flow path of the liquid medium from the container. In this case, as mentioned above, this can be further valve, or also this closing effect can be achieved by a sealing of the stretching rod on the base of the container.

In a further advantageous embodiment, the apparatus has a rod-like body (which in particular can be introduced into the containers through the mouths thereof) for expanding the containers, wherein this rod-like body has a channel for conveying the liquid medium.

In this way a hollow stretching rod can be used, through which in particular the liquid medium or in particular the product can be introduced.

In a further advantageous embodiment, the apparatus has a further receiving container to receive the liquid medium and this further receiving container is advantageously arranged below the plastics material container to be expanded. By means of this further receiving container a siphon effect can also be used in particular to draw off liquid from the container.

In a further advantageous embodiment this further receiving container is at least at times fluidically connected to the container to be expanded and/or to a further container to be expanded in another transforming station.

In a further advantageous embodiment, the apparatus has a pumping device which is suitable and intended for moving a piston element of the pressure application device at least at times. In this embodiment this pumping device is provided in an infeed of this piston element of a pumping device. This pump can move the piston element in a predetermined direction, in particular to move the piston element back into a position from which a further filling process can be carried out.

An infeed to the pressure application device is provided, by means of which the liquid to be filled is fed in particular to the pressure application device. This infeed has a valve device in order to control the delivery of liquid to the pressure application device. This valve can be closed in order to separate the pressure application device from the product delivery.

Furthermore, embodiments of the present invention are directed to a method for expanding plastics material parisons into plastics material containers by means of a liquid medium and in particular by means of a filling product, having at least one, at least two transforming stations, which fill and expand the plastics material parisons with the liquid medium. In this case at least one pressure generating device is provided, which delivers the liquid medium by means of a filling device, which filling device fills the plastics material parisons with the liquid medium. In this case the pressure generating device has a pressure output which at least at times is fluidically connected to the plastics material parison to be filled.

According to embodiments of the invention a removal device is provided which is suitable and intended at least at times to remove a flowable medium from a plastics material container, wherein the pressure generating device has a suction intake which at least at times is fluidically connected to this removal device in order to remove the flowable medium.

It is therefore also proposed in terms of the method that on the one hand the pressure generating device is used in order to convey or to press the filling material into the plastics material parison and in order on the other hand to draw off a liquid filling material from this container or another container. In this case this is advantageously a different container from the container which has just been expanded. In this case it should be noted that first the containers are expanded and then the corresponding liquid is drawn off from the head space of the containers.

The filling of a container and the drawing off of liquid medium (in particular from a further container) takes place simultaneously at least at times.

In a further preferred method, the removal of the flowable medium from the container takes place at least in part through a rod-like member, wherein this rod-like member is introduced at least at times into the plastics material container in a longitudinal direction thereof. This rod-like member expands the container in its longitudinal direction at least at times.

In a further preferred method, venting and in particular venting of the containers takes place at least at times by means of the rod-like member, wherein this venting takes place in particular using the Venturi effect.

### BRIEF DESCRIPTION

Some of the embodiments will be described in detail, with reference to the following figures, wherein like designations denote like members, wherein:

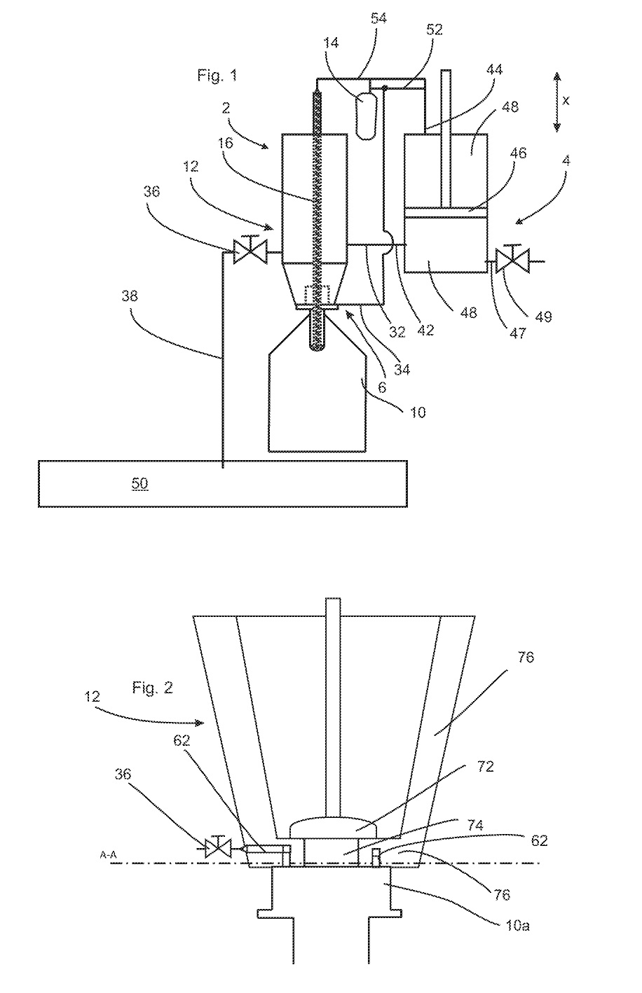

FIG. 1 shows a schematic representation of an arrangement;

FIG. 2 shows a detail of the arrangement shown in FIG. 1;

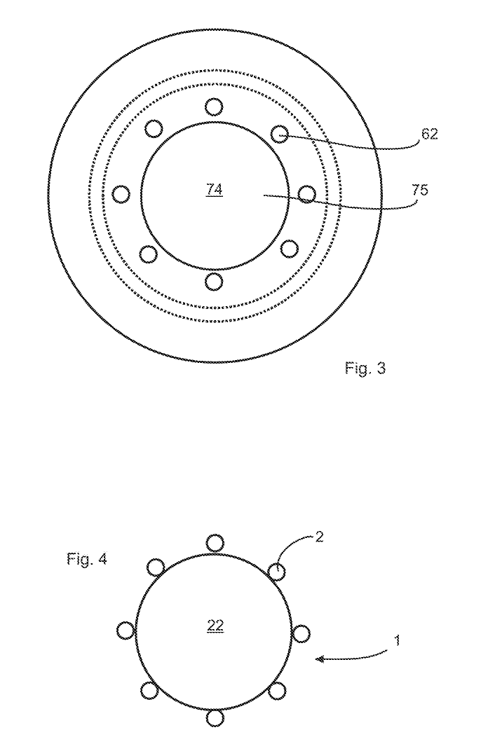

FIG. 3 shows a plan view of the representation shown in FIG. 2; and

FIG. 4 shows a rough schematic representation of an apparatus.

### DETAILED DESCRIPTION

FIG. 1 shows a schematic representation of a transforming station 2 according to embodiments of the invention. In this case the reference numeral 10 relates to a container which is expanded and simultaneously filled with the filling material. The reference numeral 16 designates a so-called stretching rod which can be introduced into the container via the mouth of the container, in order also to stretch it in its longitudinal direction during the stretching process. This stretching rod has a channel in its interior and in particular a channel which extends in the longitudinal direction of the stretching rod and through which the liquid medium can flow.

The reference numeral 4 designates a pressure generating device as a whole. This pressure generating device has a piston 46 which is movable in the direction x relative to a liquid chamber 48, in order thus to convey the liquid by means of a pressure outlet 42 via a conduit 32 to a filling device designated as a whole by 12. Starting from the filling device the liquid enters the container 10. The filling device 12 serves simultaneously as a pressure application device, in order to apply a pressure to the plastics material parisons in order to expand them.

The reference numeral 44 designates a suction intake of the pressure application device. In a movement of the piston element downwards in FIG. 1, medium is drawn in via this suction intake 44. For this purpose, a conduit 34 is provided which leads from the outlet of the filling device 12 and likewise to the mouth of the container 10. In addition, liquid can also be drawn off by means of the hollow stretching rod 16 into the connecting conduit 54. The reference numeral 14 designates a receiving container for (intermediate) storage of liquid. The reference numeral 52 designates a further conduit device. Together with the filling device which also serves here for removal of liquid, the totality of these individual conduits forms the removal device 6.

Furthermore, a conduit 38 is provided, by means of which liquid can enter a receiving container 50 due to the siphon effect. The reference numeral 36 designates a valve, in order to allow or to block this fluid stream. Thus, it would be possible to draw off liquid by means of the hollow stretching rod 16 and possibly a switchable non-return valve which could be arranged in the stretching rod. This non-return valve could prevent filling material from entering the stretching rod again. In this way, after or during the collapse of the plastics material container the container could be vented due to the siphon effect and thus the container could be brought again into its original state. A resulting temporary negative pressure due to the siphon effect could open the non-return valve and by means of a feed conduit air from the environment or also a neutral gas such as nitrogen or carbon dioxide from a tank could be supplied.

By means of the pressure in the container, during opening of this valve of the feed conduit the displaced volume in the container could be adjusted. If the feeding of the air takes place during the pressure relief, the stretching rod position would have to be deeper than 50% of the bottle height in order to prevent the gas from being flushed out of the container in the direction of the receiving container 50. Since the pressure relief takes place relatively quickly, despite the supply of air the air still cannot rise upwards so quickly that it is flushed by the siphon effect in the direction of the receiving container.

In this case a pressure below 4 bars could be maintained and no further means would be necessary for reduction of pressure.

Alternatively, the sealing of the stretching rod could also be carried out by means of contact between the ridge of the plastics material parison and the stretching rod during longitudinal stretching.

Pressing of the piston 46 would also be conceivable when pressure is relieved in a tank located further down. By pressing of the piston 46 with an opened valve 72 (cf. FIG. 2) in the filling device 12, the positive pressure which would be produced by the piston travel could prevent the collapse of containers due to the lower tank and the occurring siphon effect.

The valve 36 in the direction of the container 50 could be closed prematurely.

The last positive pressure could then be reduced by return travel of the piston 46 and/or the stretching rod. This could be controlled and/or regulated by a pressure sensor in the filling device 12 or in the container.

Furthermore, it would also be possible, that the connection 54 between the stretching rod and the receiving chamber above the piston 46 is used in order to clean the piston drive, in order for example to move the piston 46 into a position in which there is no contact with the side wall and a cleaning medium is introduced by means of a feed conduit 47 and/or a separate supplying into the connection or the individual feed conduits. The reference numeral 49 designates a valve in this feed conduit.

Overall, in this way it is possible to save a vacuum pump and the process engineering conditions of the piston drive of the piston 46 can be used. Furthermore, in this way a controlled collapse of the container is made possible by a stretching rod device or pressing of the piston 46.

Furthermore, it would also be possible to deliver a neutral gas. In the method proposed here, however, a negative pressure in the head would not be injected by the stretching rod but by the filling piston 46. The venting also would be affected by this. As mentioned above, an alternative would be to provide a non-return valve (in particular in the stretching rod) which in the event of negative pressure frees the gas path in the interior of the stretching rod. In addition, the negative pressure could also be achieved by means of the above-mentioned siphon effect. The negative pressure could also be achieved via openings in the application device or filling nozzle.

Air supplied with positive pressure can be admitted in the container, through venting holes arranged in particular horizontally in the stretching rod, and the filling level can also be adjusted on the basis of the filling level. In addition, it would also be conceivable that these venting holes are arranged vertically or are also arranged obliquely.

In a further procedure it would also be conceivable to make the container 10 and/or the filling device 12 and/or the pressure application device 4 pressureless (or to supply them with a slight positive pressure), before the removal operation and/or extraction operation is started. In this way, through the stretching rod (in particular their channel) or also through an additional conduit between the container 10 and the receiving chamber (not shown), the negative pressure is used (in particular during return travel of the piston element 46) in order to adjust the filling level.

FIG. 2 shows a detail of the filling device according to embodiments of the invention. This shows in particular the valve 72 which can also adjoin the stretching rod. The reference numeral 62 designates an outlet by means of which liquid can be drawn off from the container and can be fed for example to the conduit by the valve 36. The reference numeral 10a designates a rim of the mouth of the plastics material parison to which the filling device 12 is applied. For this purpose, the filling device can have an abutment edge 76 which is applied peripherally to the mouth of the plastics material parison.

FIG. 3 shows a detail of this region of the filling device and of the edge of the plastics material parison. This again shows in particular the openings 62, by means of which medium can be drawn off from the container, or can be removed in the event of positive pressure, and can be fed to the receiving container 50 by the siphon effect.

The reference numeral 75 likewise designates an opening through which liquid can flow. The reference numeral 74 designates the filling material flowing into the container 10, i.e. the liquid to be filled.

FIG. 4 finally shows a rough schematic representation of an apparatus 1 according to embodiments of the invention. This has a rotatable carrier 22 on which a plurality of transforming stations 2 are arranged. In this case, as mentioned above, it would also be possible that a container is shaped or filled by a first transforming station 2 and liquid is drawn off from a container which is just being handled by a further transforming station.

In this way it is possible that an individual piston or an individual pressure application device 4 is associated with each transforming station. However, it would also be possible that a pressure application device is associated with several transforming stations. In addition, flow connections can also be provided between a transforming station 2 and the pressure application device which is associated with a further transforming station.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

### LIST OF REFERENCE SIGNS

1 apparatus
2 transforming station
4 pressure generating device
10 container
10a rim of the mouth
12 filling device
14 receiving container
16 stretching rod
22 carrier
32 conduit
34 conduit
36 valve
38 conduit
42 pressure outlet
44 suction intake
46 piston
47 feed conduit
48 liquid chamber
49 valve
50 receiving container
52 conduit device
54 connecting conduit
62 outlet, opening
72 valve
74 liquid to be filled
75 opening
76 abutment edge
X direction of movement

1. An apparatus for expanding plastics material parisons into plastics material containers by a liquid medium having at least one transforming station, which fills and expands the plastics material parisons with the liquid medium with at least one pressure generating device, which is suitable and intended to deliver the liquid medium to at least one filling device, which filling device fills the plastics material parisons with the liquid medium, wherein the pressure generating device has a pressure output which at least at times can be fluidically connected to the plastics material parison to be filled, wherein the apparatus has a removal device which is suitable and intended at least at times to remove a flowable medium from a plastics material container, wherein the pressure generating device has a suction intake which at least at times can be fluidically connected to this removal device in order to remove the flowable medium.

2. The apparatus according to claim 1, wherein the pressure generating device has a piston element which is movable relative to a liquid chamber.

3. The apparatus according to claim 1, wherein the apparatus has a movable or stationary carrier on which the transforming stations are arranged.

4. The apparatus according to claim 1, wherein the apparatus has a receiving device for liquid medium removed from the container.

5. The apparatus according to claim 1, wherein the apparatus has a closing device in order to close a flow path of the liquid medium from the container.

6. The apparatus according to claim 1, wherein the apparatus has a rod-like body for expanding the containers, wherein this rod-like body has a channel for conveying the liquid medium.

7. The apparatus according to claim 1, wherein the apparatus has a further receiving container to receive the liquid medium and this further receiving container is advantageously arranged below the plastics material container to be expanded.

8. The apparatus according to claim 7, wherein the further receiving container is fluidically connected at least at times to the container to be expanded.

9. A method for expanding plastics material parisons into plastics material containers by a liquid medium, with at least one transforming station, which fills and expands the plastics material parisons with the liquid medium, wherein at least one pressure generating device delivers the liquid medium to at least one filling device, which filling device fills the plastics material containers with the liquid medium, wherein the pressure generating device has a pressure output which at least at times is fluidically connected to the plastics material parison to be filled, wherein the apparatus has a removal device which at least at times removes a flowable medium from a plastics material container, wherein the pressure generating device has a suction intake which at least at times is fluidically connected to this removal device in order to remove the flowable medium.

10. The method according to claim 9, wherein the removal of the flowable medium from the container takes place at least in part through a rod-like member, wherein this rod-like member is introduced at least at times into the plastics material container in a longitudinal direction thereof.

11. The method according to claim 9, wherein venting takes place at least at times by the rod-like member, wherein this venting takes place in particular using the Venturi effect.
